(19) United States
(12) Patent Application Publication
(10) Pub. No.: US 2013/0022332 A1
(43) Pub. Date: Jan. 24, 2013

(54) Simulated Graphical Replay of a Sporting Event

(71) Applicants: Josiah Platt, Dallas, TX (US); Keon Byrd, Allen, TX (US); Charles Williams, The Colony, TX (US); Luke Keith, Lucas, TX (US); Jon Cameron, Dallas, TX (US)

(72) Inventors: Josiah Platt, Dallas, TX (US); Keon Byrd, Allen, TX (US); Charles Williams, The Colony, TX (US); Luke Keith, Lucas, TX (US); Jon Cameron, Dallas, TX (US)

(73) Assignee: SYMFONO, INC, Addison, TX (US)

(21) Appl. No.: 13/624,036

(22) Filed: Sep. 21, 2012

(51) Int. Cl. H04N 5/775

(52) U.S. Cl. 386/230; 386/E05.07

(57) ABSTRACT

A method of generating missing data in sports play data. The actual data and simulated data are then combined to create a graphical replay system that allows users to quickly analyze ball movement on the playing field.

### BACKGROUND

1. Field of Invention

The invention relates to the system and method of reviewing plays that occurred on a sports field.

2. Background of the Invention

The present invention is a useful and novel method for recording plays in a sporting event, determining gaps in the play data, and simulating the data gaps as movement on the field. This method replaces video replay systems that dominate the broadcast and mobile application markets.

Sports replay systems are electronic video-based capabilities to highlight key events during a live broadcast.

### Early Replay Systems

Sports replay systems began in the 1950s during Canadian Hockey games. Within a few years, the technology had quickly advanced to be able to provide primitive slow-motion capabilities. However, the early system had dodgy performance and could weigh an un-portable hundreds of pounds. Fans saw the new playback as controversial and confusing. They often were unsure if they were seeing a second touchdown or if it was a replay of earlier touchdown.

It wasn't until 1967, when replay systems were run off analog-storage, did capabilities meet broadcasting and cultural needs. For broadcasters, the new system had 30 second capabilities which allowed them to provide unbroken chatter by continuously reviewing previous plays. For fans, the new analog systems provided true slow-motion capabilities that clearly separated live broadcast from replay broadcast. The adoption roadblocks were removed and within a few years, replay systems were both common place and an expected practice for live sport event broadcasting.

In a symbiotic relationship with the very sports broadcasted with replay, televised football saw a rapid rise in viewership because of the replay systems gave fans an entirely new way to view, analyze and understand the sport.

Replay systems, both then and now, share similar problems addressed by a graphic replay systems of the present invention. Any video-based system requires fans to be able to distinguish key actions on a field cluttered with action.

Telestrator over Video for Key Plays

Telestrator is a video marker that allows a sport broadcaster to draw a freehand sketch over the moving or still instant replay video. NFL broadcaster John Madden was famous for his use, sometimes over use, of the telestrator for analyzing key plays using a series of sketched arrows, lines, X's and O's.

The telestrator demonstrated the need for reducing the complexity of a field of player actions down to key actions that led to a foul, error, injury, or the conclusion of a play.

However, the telestrator has its problems. One, it is drawn against the very background of the complexity it is designed to simply. Two, the overlay can obstruct a view of the action. Three, as John Madden proved, the clarity of the overlay is limited to skills of the multi-tasking broadcaster.

The present invention addresses all three of the telestrator's problems.

### Modern Video Replay

Today, broadcasters and referees have a range of video replay solutions that provide both practical and visually-appealing effects. Some of the new capabilities include the ability to simulate a frame-by-frame replay; to zoom in and freeze frame on key action such as foot placement on a sideline; replay at a variable speed in a single replay; split screens to show replay and live video simultaneously, timers synced to game play for foul and scoring decisions; overlaying of augmented reality graphics to show key field positions such as 1^{st} down line; removal of graphics from original footage; adding of replay sponsor's advertising; split screens to show multiple replays of the same action; and exciting 3-D capabilities that allow the broadcaster to spin around an event to show it from multiple viewpoints within a single freeze frame.

All of these modern capabilities are designed to address the benefits of the present invention: to refocus field activity so sports fans can discriminate key actions.

### Home Video Replay

Sports fans also now commonly have in-home digital video recorders (DVR) with 50% of the United State's households having a DVR. DVRs provide consumers with the ability to personalize video replay to suit their individual needs. Consumers can replay live sports events or replay recorded video.

However, the systems are often difficult to control precise start and freeze times. They also lack the key capabilities of modern professional systems that allow sports commentators to highlight key actions. Coupling home DVR capabilities with the present graphical replay invention helps solve the problem of analyzing key plays using only a DVR.

### Modern Mobile Applications

Today, many applications attempt to help players, coaches and fans better understand sport play and movement. New capabilities on mobile devices allow coaches telestrator like capabilities on moving or freeze-frame video. Other apps link video commentators analysis to either graphics or video segments.

Modern mobile applications still lack the ability to provide the benefits of the present invention which provides a simplified view of the order of connected events for rapid analysis of every play within a game.

### Statistical Collection Services

Capture on-field play routes has always been a challenge by sports statistics collection companies.

While unassisted ball movement is fairly simple to represent as beginning and end coordinates, player movement is problematic to record in a written data set. Without considering the curve and arch of ball movement, once a ball is projected away from the player, it follows a relatively straight line between the two coordinates.

However, the complications begin as we then add the movement of the players on the field. For instance, a player that is preparing for a shot to the goal may first dribble the ball forward, then around defender's charge, turn with the ball, dribble again, and finally shoot toward the goal. The single play could involve dozens of coordinates and action records. Unable to overcome the collection challenges of player's nonlinear moves, statistics companies have simply ignored the movement of the ball when it is assisted and controlled by the player.

The present invention solves the issue for sport data route suppliers by fabricating movements of players when they are carrying, dribbling, or otherwise moving with, and controlling, the ball.

### Description of First Key Element of Prior Art

Video Replay Systems. Video replay systems are problematic as consumers move to both wireless and mobile broadcasting. A ninety (90) minute match can take as much as 500 megabytes of space on the mobile device. This creates large storage and cache requirements on both the server application and the mobile device. While typically these types of storage problems could be addressed by cloud-based software solutions, the requirements of reply make the final display both difficult to locate within the video stream, but cumbersome to display.

### Description of Second Key Element of Prior Art

Incomplete data streams. Statistics suppliers, such as Stats, LLC, provide data streams of game activity in the form of unparsed alpha-numeric codes. However, these data streams can only track relatively simple movements on the field. For instance, a ball travels a relatively straight path when a rugby player passes a ball. So statistics suppliers can record the location from where the ball was passed, and the point where the ball was received, to determine the flight path of the ball. However, the same rugby player running with a ball may have to backtrack, out-maneuver defenders and dodge flying tackles. This can require the nearly-impossible task of recording every running angle, the pace, and distance. Therefore, data suppliers record the movement only when the ball is projected away from one player and the ending point of that projection.

### Description of Third Key Element of Prior Art

Graphic display is not sequenced. Existing systems attempt to overcome the data gaps in the statistical data in a variety of ineffectual ways. The common way is simply to not show any sequence to the data. For example, the display will show the position of the players during a foul, but not the events that led to the foul. The second method is simply to display every pass, shot, kick, deflection, carry and dribble on one screen and let the user determine the order. The result is like trying to find the rooster's tracks on the floor of a busy hen house.

### Description of Fourth Key Element of Prior Art

Graphics only show plays leading to a key event. To bypass the chicken scratch of not sequencing the plays on a graphical field, other applications have attempted to focus on displaying only the sequence of key events. For instance, one application shows the plays and shots leading up to a goal. The application is unable to display sequences for the entire game and therefore is only a very limited replay application.

Another application shows the position of each player during a key event, such as a goal, and then uses a written narrative from the live audio broadcast to describe the sequence of plays that led to the goal. Since these narratives are word-for-word translations of the sports broadcaster's requirement to have constant chatter during game time, the capturing of a single segment of the verbal broadcast doesn't often tie accurately to the play being graphically represented.

### SUMMARY OF THE INVENTION

An invention, which meets the needs stated above, is a system and method to replay key events in a sports play sequence and then manufactures player's movement with the ball to create seamless graphical representation of a set of plays on a sports field. This replaces traditional video replay systems and helps to focus the sports fan on key movement.

### OBJECTS AND ADVANTAGES

Accordingly, besides the objects and advantages described of the sim-line in Simulated Graphical Replay of a Sporting Event, further objects and advantages of the present invention are:
a) to provide sequencing of events despite gaps in play data;
b) to provide a visual display of the entire game, not just key events;
c) to provide a sequencing of plays without the need of video;
d) to provide simplified visual representation of movement on the field by only showing 1) players moving with the ball, and 2) the ball's movement without player control.
e) to provide a simplified display by not showing defensive players.

Further objects and advantages of this invention will become apparent from a consideration of the drawings and the ensuing description of the drawings.

### DRAWING FIGURES

The accompanying drawings, which are incorporated in and constitute a part of this specification, illustrate embodiments of the present invention and together with the description, serve to explain the principles of this invention. In the figures;

FIG. 1A.—Flow chart depicting the collection and display of a single ball-line and sim-line.

FIG. 1B.—Flow chart depicting the collection and display of a single sim-line and two ball-lines for a total of three sequential plays.

FIG. 2A.—Drawing illustrating the use of the invention to display the basic elements of players and ball-lines.

FIG. 2B.—Drawing illustrating the use of the invention to display the key elements of players, ball-lines and a sim-line.

### KEY TERMS

Ball-line: a graphical line representing the movement of the ball after it is projected away from a player, such as a kick, throw, shot, header, deflection or pass.

Carrier: a player that has possession of the ball. The movement of the ball carrier is projected for this invention.

Carrying the ball: a foul called on a goalkeeper when the goalkeeper has taken more than four (4) steps while bouncing or holding the ball.

Defenders: the players on the team without possession of the ball. Defenders are not considered for this invention.

Deflection: a ricochet of the ball off a player.

Dribbling: a player advancing the ball with their feet.

Football: name for soccer everywhere except in the U.S.; also, what American's call their popular team sport which evolved from soccer and rugby.

Fore-play: the first of a two-part play that begins with a dribble. The dribbling is not recorded and is missing from the data. Compare Hind-play.

Goal: a ball that crosses the goal line between the goalposts and below the crossbar.

Header: when a player strikes an air ball with the player's head.

Hind-play: the second of a two-part play that begins with a dribble. The hind-play move is used to calculate the fore-play's missing data. Compare Fore-play.

In bounds: when the ball is within the boundaries of the field.

In play: when the ball is within the boundaries of the field and play has not been stopped by the referee.

Kick: Striking the ball with any part of the foot beside the in-step.

Match: a soccer game.

Moves: footwork including dribbling, feints, and turning with a soccer ball.

Passing: when a player kicks the ball to his teammate (receiver) in order to 1) move the ball closer to the opposing goal, 2) give the ball to a player who is in a position to score, 3) keep the ball away from an opponent. Passing can also include plays without a kick, such a chest pass, but this is relatively rare.

Play: when a player kicks, traps, dribbles, heads the ball. In the present invention, all displayed lines represent some form of play.

Possession: team or player with control of the ball.

Receiver: a player who gets a pass from a teammate.

Shooting: when a player, or attacker, kicks the ball at the opponent's net in an attempt to score a goal.

Shot: an attempt to score a goal when a ball is kicked or headed by a player at the opponent's net.

Sim-line: A graphic simulating the shortest distance a player would have traveled with a ball, such as a dribble or carry. Compare ball-line.

Trap: when a player uses his body (generally chest, thighs or feet) to slow down and control a moving ball.

### REFERENCE NUMERALS IN DRAWINGS

10 Field, Court, Known Geometry
20 Player, First Player
25 Receiver, Second Player, Carrier
40 Ball
50 Initial Position of the Player or Receiver, Initial Position
60 Ending Location of the Ball, Ending Location
70 Sim-line, Shortest Distance Trajectory, Player+Ball, Dribble, Carry
80 Ball-line, line between player and ending location of the player's pass of the ball.

### DETAILED DESCRIPTION OF THE DRAWINGS

Referring to the drawings, in which like numerals represent like elements,

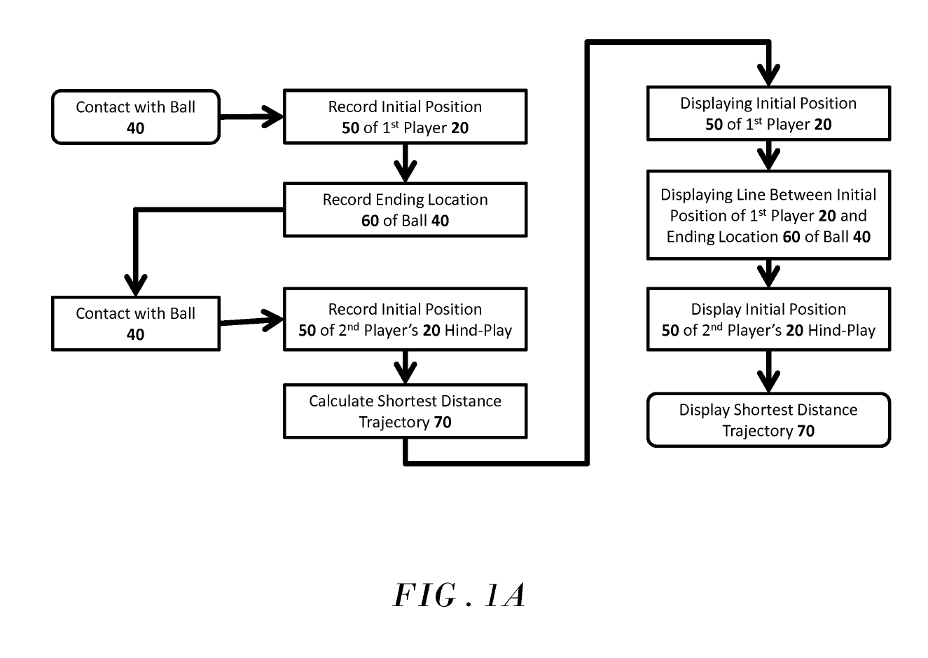

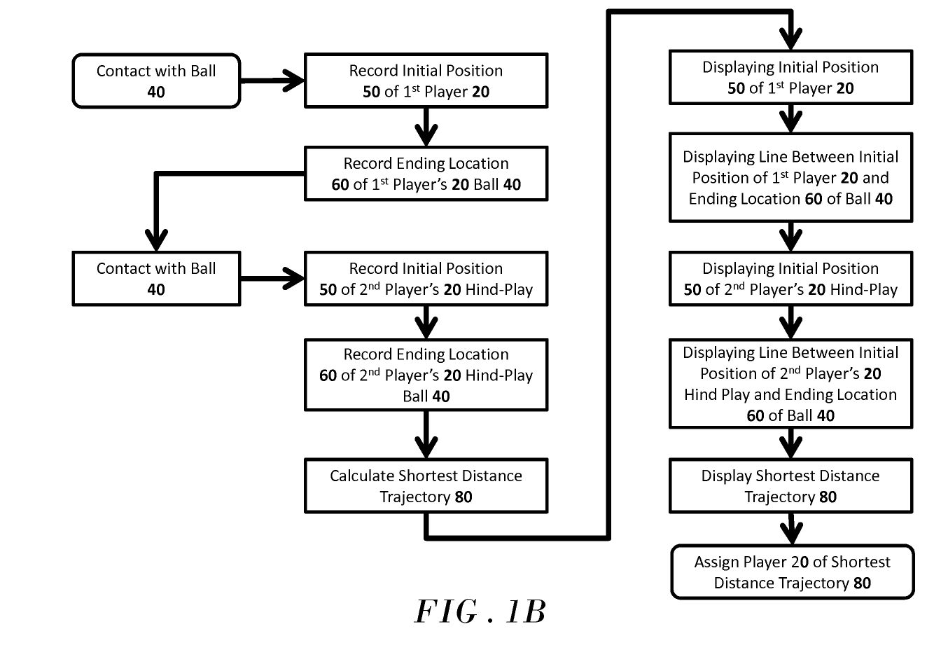

FIG. 1A

Turning first to FIG. 1A, the logic flow chart depicts the recording and display of an event series that includes a single sim-line 70 and one ball-line 80 for a total of two sequential plays.

The event series begins with a player's 20 contact with the ball 40. If the contact results in the ball 40 being projected away from the player 20, such as in a pass or kick, the statistic provider records four pieces of information for a single play:
1. The location on the field 10 from where the ball 40 was projected;
2. The location on the field 10 where the path of the ball 40 was stopped or redirected by another player 25.
3. The type of play (kick, pass, shot, header, throw, deflection);
4. The name of the player 20.

Since contact was made by the player 20, we can use the first location of the projected ball 40 to record the initial position 50 of the player 20.

In item number 2 above, the data has already given us the path and stopping point of the ball 40. Since the subsequent movement of the ball 40 would have been done by receiver 25, we can also project the position of this receiver 25.

At this point we have recorded, either from the two data records or by supposition, five points of information.
1. The initial position 50 of first player 20;
2. The ending location 60 of the first player's 20 ball 40;
3. The type of play of the first player 20 (kick, pass, shot, header, throw, deflection);
4. The name of the first player 20;
5. The initial position 50 of the player 25 that received the ball 40, from the first player 20. This person is referred to as the receiver 25.

Note that while we know there is a receiver 25, we do not yet know:
1. The name of the receiver 25;
2. The plays by the receiver 25;
3. The ending locations 60 of the receiver's 25 hind-play (see below this page).

It would seem natural the data company would then provide the information on this receiver 25. However, the next play on the field 10 may not be the next play in the data. If this data is missing, it will not be provided anywhere else in the data stream.

The next recorded ball 40 contact made by a player 25 may be in a different location than the ending location 60 of first player's 20 ball 40.

If the next record of the location of the ball's 40 kick or pass is not the same as the ending location 60 of the first player's ball 40, the present invention proposes a new method to determine the missing data.

The present invention presumes that a receiver 25 who dribbles 70, or carries 70, the ball 40 will engage in a two-part play encompassing:
1. Fore-play of a player's 25 movement while controlling the ball 40, such as dribbling. Dribbling is not recorded and is missing from the data.
2. Hind-play of projecting the ball 40 away from the player 25, such as a kick or pass. This is the second record in this example because it is the next record where the ball 40 is propelled away from the player 25.

However, we only need a portion of the hind-play record to determine the fore-play dribble 70. By recording only the initial position 50 of the second data record, the invention can create a simulated travel line, or sim-line 70, of the receiver's 25 fore-play.

The sim-line 70 is then calculated as the shortest distance trajectory 70 between ending location 60 of previous record and initial position 50 of the next record.

Comparing now to FIG. 1B, the claims add a new piece of information to the claim: ending location 60 of second player's 25 hind-play ball 40. This allows the display of three lines: two ball-lines 80 and one sim-line 70.

By using a full data record of FIG. 1B, the present invention can now record, either from the data stream, or by calculation, eleven (11) points of information from only two (2) data records.
1. The initial position 50 of first player 20;
2. The ending location 60 of the first player's 20 ball 40;
3. The type of play of the first player 20 (kick, pass, shot, header, throw, deflection);
4. The name of the first player 20;
5. The fore-play position 50 of the player 25 that received the ball 40, from the first player 20.
6. The fore-play location 60 of both the receiver's 25 ball 40 and the receiver 25;
7. The name of the receiver 25;
8. The type of play in the fore-play by the receiver 25 (dribble 70);
9. The initial position 50 of the hind-play by the receiver 25;
10. The ending location 60 of the ball 40 played by the receiver 25 in the hind-play;
11. The type of play in the hind-play by the receiver 25.

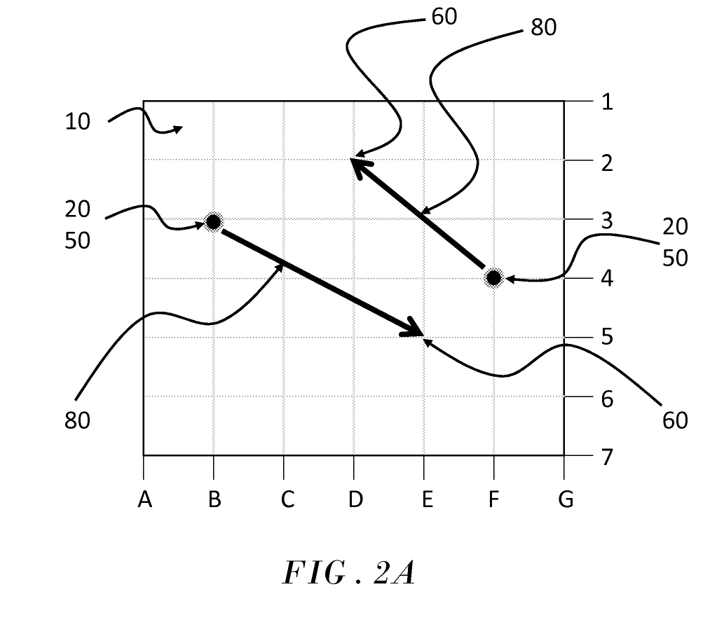

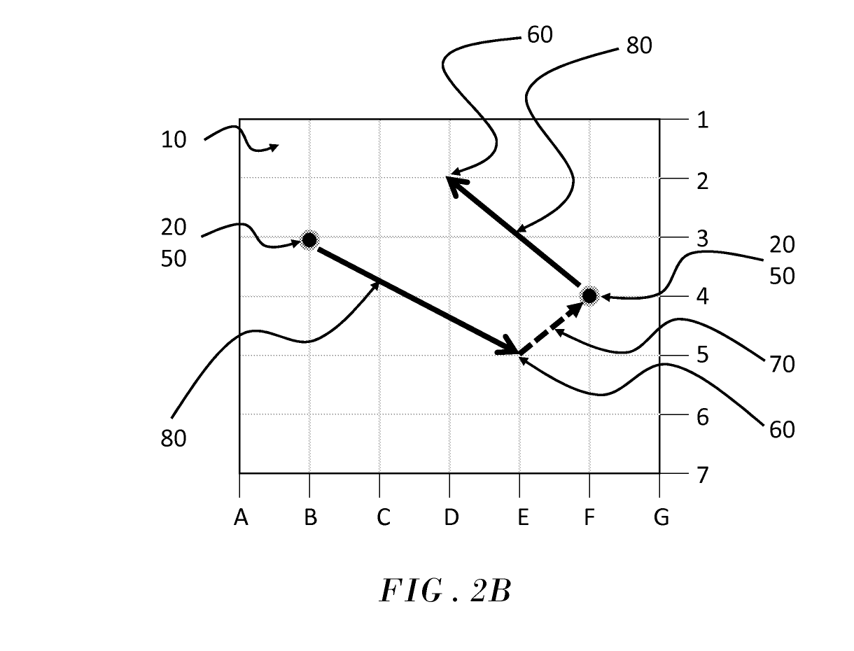

FIGS. 2A and 2B

FIG. 2A depicts the use of the invention to display plays on a field 10, or known geometry 10, comprising thirty-six (36) grids, each grid a dimension of five (5) feet by five (5) feet.

In the present example FIG. 2A, the data from the statistics provider would contain two pieces of data:
1. Player 20 Smith kicks ball 40 eighteen (18) feet from B3 to E5
2. Player 25 Jones passes ball 40 twelve (12) feet from F4 to D2

The first step is to plot the two plays as ball-lines 80 on the representative field 10 using solid dark lines. Ball-lines 80 can represent a variety of plays where the ball 40 is projected away from the player 20 either by force applied by the player 20 in possession of the ball 40, or by deflection off of the player 20. The ball-line 80 includes kicks, pass, shots, headers, carries, throws, chest passes and body deflections.

However, the two ball-lines 80 alone provide an unordered view of events. It is unclear to the observer of the graphic if Jones passed before Smith kicked the ball 40.

The two ball-lines 80 are also not connected leaving an open question of what events occurred between the kick and pass.

All of this is because the limited amount of data relayed by the statistics providers are insufficient to graphically represent sports play. Therefore it requires a new method to allow the graphics to show order and sequencing of connected events during a match.

FIG. 2B represents the subsequent function of the present invention showing the simulated play line, or sim-line 70. In the figure, we can show three (3) plays even though the data is still only showing the same two (2) plays:
1. Player 20 Smith passes ball 40 eighteen (18) feet from B3 to E5
2. Player 25 Jones kicks ball 40 twelve (12) feet from F4 to D2

We know that Smith passed the ball 40 to E5 where a receiver 25 had to trap and move the ball 40 to the initial position 50 of the next play 50 at F4. Since the play data only contains information of when the ball 40 is traveling without an adjacent player 25, we project the missing data is when the ball 40 was moved by a carrier 25—such as in a dribble 70.

However, we don't know the exact path of the carrier 20 from E5 to F4 because the data is silent on this play action. The player 25 could have dribbled to D2 and then dribbled back to F4 where the same player 25 kicked the ball 40. Therefore we can project a dribble 70, or sim-line 70, as a line drawn from the end of the pass of the previous play to the initial position 50 of the second player 25 in the dataset.

The present invention also then assumes the second player 25 in the event series is the same player 25 for the sim-line 70.

So the system is able to entirely project all necessary information in simulated play including start time, end time, start location, end location the ball 40, the type of play, and the player 25 involved.

By adding this simulated play line, the graphic becomes clear and we can see a contiguous play that involves an event series of a pass, a dribble 70, and a kick.

Benefits, other advantages, and solutions to problems have been described herein with regard to specific embodiments. However, the advantages, associated benefits, specific solutions to problems, and any element(s) that may cause any benefit, advantage, or solution to occur or become more pronounced are not to be construed as critical, required, or essential features or elements of any or all the claims of the invention. As used herein, the terms “comprises”, “comprising”, or any other variation thereof, are intended to cover a non-exclusive inclusion, such that a process, method, article, or apparatus composed of a list of elements, that may include other elements not expressly listed or inherent to such process, method, article, or apparatus.

### Advantages

From the description above, a number of advantages become evident for the “Simulated Graphical Replay of a Sporting Event.” The present invention provides all new benefits for participating parties including sport fans, coaches, athletes; sport franchises, broadcasters, and mobile application developers, such as:
a. Allows sport fans to study offensive play without the clutter of video replays;
b. Allows defense coaches to quickly review opponents offensive plays;
c. Allows offensive coaches to systematically review own-team plays with athletes;
d. Allows athletes to review key plays faster than video replay systems;
e. Allows sports franchises to develop applications for fans to review live-event plays using lower data download requirements;
f. Allows sports franchises new opportunities to provide live-event advertising to replay mobile applications;
g. Allows broadcasters to use computer-generated graphics to emphasize key field movements without manually writing over the video image.
h. Allows mobile application developers to simplify on-field graphics.
i. Allows mobile application developers clean screen space to display advertising;
j. Allows mobile applications developers to display missing dribble information;
k. Allows mobile applications developers to display the name of the dribbler as the next player in the data sequence;
l. Allows mobile applications developers to provide live-event replay in countries with limited mobile data packages, such as pre-sold data plans.

What is claimed is:

1. A method of graphically representing a fabricated movement of a player during a sporting event, the method comprising:
a. Recording an initial position of a first player by identifying contact with a ball within a known geometry;
b. Recording an ending location of a first player's pass of the ball within the known geometry;
c. Recording an initial position of a second player by identifying contact with the ball within the known geometry;
d. Calculating a shortest-distance trajectory between the ending location of first player's pass of the ball and the initial position of a second player;
e. Displaying the initial position of the first player on a known geometry;
f. Displaying a line between the initial position of the first player and the ending location of the first player's pass of the ball.
g. Displaying the initial position of the second player on the known geometry;
h. Displaying the shortest-distance trajectory;
whereby, the graphical representation combines actual and simulated ball movement.

2. A method of claim 1, wherein said known geometry is the axis of a soccer field.

3. A method of claim 1, wherein said known geometry is the axis of a hockey field.

4. A method of claim 1, wherein said known geometry is the axis of a basketball court.

5. A method of claim 1, wherein said displaying of the shortest-distance trajectory is a solid line.

6. A method of claim 1, wherein said displaying of the shortest-distance trajectory is a moving line.

7. A method of graphically representing a fabricated movement of a player during a sporting event, the method comprising:
a. Recording an initial position of a first player by identifying contact with a ball within a known geometry;
b. Recording an ending location of a first player's pass of the ball within the known geometry;
c. Recording an initial position of a second player by identifying contact with the ball within the known geometry;
d. Recording the ending location of a second player's pass of the ball within the known geometry;
e. Calculating a shortest-distance trajectory between the ending location of first player's pass of the ball and the initial position of a second player;
f. Displaying the initial position of the first player on a known geometry;
g. Displaying a line between the initial position of the first player and the ending location of the first player's pass of the ball.
h. Displaying the initial position of the second player on the known geometry;
i. Displaying a line between the initial position of the second player and the ending location of the second player's pass of the ball.
j. Displaying the shortest-distance trajectory;
whereby, the graphical representation combines actual and simulated ball movement.

8. A method of claim 7, wherein said known geometry is the axis of a soccer field.

9. A method of claim 7, wherein said known geometry is the axis of a hockey field.

10. A method of claim 7, wherein said known geometry is the axis of a basketball court.

11. A method of claim 7, wherein said displaying of the shortest-distance trajectory is a solid line.

12. A method of claim 7, wherein said displaying of the shortest-distance trajectory is a moving line.

13. A method of graphically representing a fabricated movement of a player during a sporting event, the method comprising:
a. Recording an initial position of a first player by identifying contact with a ball within a known geometry;
b. Recording an ending location of a first player's pass of the ball within the known geometry;
c. Recording an initial position of a second player by identifying contact with the ball within the known geometry;
d. Recording the ending location of a second player's pass of the ball within the known geometry;
e. Calculating a shortest-distance trajectory between the ending location of first player's pass of the ball and the initial position of a second player;
f. Displaying the initial position of the first player on a known geometry;
g. Displaying a line between the initial position of the first player and the ending location of the first player's pass of the ball.
h. Displaying the initial position of the second player on the known geometry;
i. Displaying a line between the initial position of the second player and the ending location of the second player's pass of the ball.
j. Displaying the shortest-distance trajectory;
k. Calculating the player of shortest-distance trajectory as the second player.
whereby, the graphical representation combines actual and simulated ball movement to show the player and play of missing data.

14. A method of claim 13, wherein said known geometry is the axis of a soccer field.

15. A method of claim 13, wherein said known geometry is the axis of a hockey field.

16. A method of claim 13, wherein said known geometry is the axis of a basketball court.

17. A method of claim 13, wherein said displaying of the shortest-distance trajectory is a solid line.

18. A method of claim 13, wherein said displaying of the shortest-distance trajectory is a moving line.
